(19) United States
(12) Patent Application Publication
(10) Pub. No.: US 2006/0144211 A1
(43) Pub. Date: Jul. 6, 2006

(54) Data input device and data input method

(75) Inventor: Itsuro Yoshimoto, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yoshimoto Inc., Sunnyvale, CA (US)

(21) Appl. No.: 11/283,510

(22) Filed: Nov. 18, 2005

Related U.S. Application Data
(63) Continuation-in-part of application No. PCT/US05/12009, filed on Apr. 11, 2005.
(60) Provisional application No. 60/629,546, filed on Nov. 19, 2004.

(51) Int. Cl. G10H 1/00

(52) U.S. Cl. 84/615

(57) ABSTRACT

An efficient and user friendly data entry device and data entry method. At least a first symbol and a second symbol are printed on a key-top, and at least a first switch and a second switch are provided corresponding to the symbols. The first switch is activated when the first symbol is pressed, and the second switch is activated when the second symbol is pressed. When more than two switches are activated simultaneously, a predetermined output is provided.

### CROSS-REFERENCES TO RELATED APPLICATIONS

This application claims the benefit of Provisional Application No. 60/629,546, filed Nov. 19, 2004 and is a continuation in part of PCT Application No. PCT/US05/12009, each of which is commonly assigned and hereby incorporated by reference in their entirety.

### FIELD OF THE INVENTION

The present invention relates to data input device. More specifically, the present method and system includes a key arrangement on a handheld electrical device such as a mobile telephone. Merely by way of example, the key arrangement can be applied to a cellular phone product, but can also be applied to game consoles, remote controls for television and/or computing devices, personal digital assistants, other phone products, cordless phones, any combination of these, and the like.

### BACKGROUND OF THE INVENTION

Using mobile phones for data services, such as e-mail and SMS, is becoming more and more popular. Users are accustomed to the conventional mobile phone key arrangement of FIG. 1A, with 12 keys in three columns by four rows. As shown, each key is used primarily to input a single number 0-9 or a function * or #. Some of the keys are also used to input letters A-Z or symbols like @ and ?, requiring often multiple presses of the same key. Given the size of the keypad, easy, quick and accurate key input of the letters and symbols for data services is a critical issue.

U.S. Patent Application Publication No. 200210110237 discloses a cluster key arrangement. Each of the keys has a primary key for numbers or functions, and secondary keys for letters or symbols. The primary key and secondary keys of a key are configured in a mutually exclusive manner, mechanically by a secondary key mutual exclusive actuator, or electronically by a pressure-sensitive input device including an X-coordinate detection resistive element and a Y-coordinate detection resistive element. However, the cost for manufacturing the mutually exclusive primary and secondary keys on the small keypad of a handheld device is high.

FIG. 2 shows a conventional tactile (TACT) switch used in a key of a mobile phone. A number “9” and letters “WXYZ” are printed on a key-top 201 of the key. A dome switch 202 is mounted on the printed circuit board under the key-top. In the phone operation mode, the number 9 will appear on the screen of the phone when a user presses the key. In the e-mail operation mode, the number 9 and letters W, X, Y, and Z will appear on the screen serially when a user presses the key. The user needs to press the same key several times to select the number or letter he/she needs. The selection significantly slows down the input speed.

For example, to type the phrase “high-5”, a user needs to press the key with the number 4, to which letters G,H, and I are also assigned, eight times plus waiting time, including two times for h; wait; three times for i; wait; one time for g; wait; and two times for h. Each waiting time is 2-3 seconds on average. Then the user needs to press the key with number 1, to which symbols are assigned, several times until the symbol “-” appears, then press the key with number 5 four times.

Therefore, it would be desirable to provide a data input device providing easy, quick and accurate key input of letters and symbols at low production cost.

### BRIEF SUMMARY OF THE INVENTION

In view of the foregoing, it an object of the present invention to provide an efficient and user friendly data entry device and data entry method. Merely by way of example, the key arrangement can be applied to a cellular phone product, but can also be applied to game consoles, remote controls for television and/or computing devices, personal digital assistants, other phone products, cordless phones, any combination of these, and the like.

In accordance with the above and other objects, the invention provides a data entry device having at least a first symbol and a second symbol printed on a key-top, and at least a first switch and a second switch are provided corresponding to the symbols. The first switch is activated when the first symbol is pressed, and the second switch is activated when the second symbol is pressed. When more than two switches are activated simultaneously, a predetermined output is provided.

The invention also provides a method for controlling the data entry device. Signal ports of the data entry device are scanned to determine whether the state of the data entry device has changed. If yes, the number of switches being pressed is determined, and then possible outputs according to the number of switches being pressed is determined.

In a specific embodiment, the invention provides a telecommunication device. The telecommunication device comprises a housing member. The telecommunication device can be a cellular phone, or other wireless devices. The telecommunication device also comprises a key board which includes a plurality of keys representative of a set of numbers including 0, 1, 2, 3, 4, 5, 6, 7, 8, and 9. The keyboard is coupled to the housing member. The telecommunication device comprises also one or more of the keys. The one or more keys represent at least a first character and a second character Each of the keys comprises a first portion and a second portion. The telecommunication device also comprises a first switch.

The first switch is activated when the first portion of the key is pressed. The telecommunication device comprises a second switch. The second switch is activated when a second portion of the key is pressed;. The telecommunication device also includes a conversion device coupled to the first switch and the second switch. The conversion device has a first input coupled to the first switch and a second input coupled to the second switch. The first input is capable of transferring a first output indicative of the first character and the second input is capable of transferring a second output indicative of the second character The conversion device is also adapted to produce a third character upon receiving an input from both the first switch and the second switch when the first switch and the second switch are activated simultaneously.

In an alternative embodiment, the invention provides a remote controller device. The remote controller device comprises a housing member for a wireless communications. The remote controller device comprises a key board. The keyboard comprises a plurality of keys representative of a set of numbers including 0, 1, 2, 3, 4, 5, 6, 7, 8, and 9. The keyboard is coupled to the housing member. The remote controller device also comprises one or more of the keys. Each of the one or more of the keys represent at least a first character and a second character. Each of the one or more keys also includes a first portion and a second portion. The remote controller device comprises a second switch. The second switch is activated when a second portion of the key is pressed;. The remote controller device also includes a conversion device coupled to the first switch and the second switch. The conversion device has a first input coupled to the first switch and a second input coupled to the second switch. The first input is capable of transferring a first output indicative of the first character and the second input is capable of transferring a second output indicative of the second character The conversion device is also adapted to produce a third character upon receiving an input from both the first switch and the second switch when the first switch and the second switch are activated simultaneously.

### BRIEF DESCRIPTION OF THE DRAWINGS

Embodiments of the present invention are described herein with reference to the accompanying drawings, similar reference numbers being used to indicate functionally similar elements.

FIG. 1A shows a conventional mobile phone key arrangement.

FIG. 1B shows a key silk print of a mobile phone according to one embodiment of present invention.

FIG. 2 shows a conventional TACT switch used in a key of a mobile phone.

FIGS. 3A to 3E show a key of a mobile phone according to one embodiment of the present invention.

FIG. 4 shows a key according to one embodiment of the present invention.

FIGS. 5A and 5B show a key according to another embodiment of the present invention.

FIG. 6 shows a key according to another embodiment of the present invention.

FIGS. 7-14 (including FIGS. 14A, 14B, 14C, 14D, 14E, 14F, 14G, and 14H) show additional embodiments of the key of the present, invention.

FIG. 15 shows a flowchart for controlling data input of a key with the key-top assignment of FIG. 1E according to one embodiment of the present invention.

FIGS. 16A-16C show a tutorial model according to one embodiment of the present invention.

FIGS. 17A and 17B show a tutorial model according to another embodiment of the present invention.

FIG. 18 shows a flowchart for selecting an input conversion table according to one embodiment of the present application.

### DETAILED DESCRIPTION OF THE INVENTION

Objects and advantages of the present invention will become apparent from the following detailed description. The following description of illustrative, non-limiting embodiments of the invention discloses specific configurations and components. However, the embodiments are merely examples of the present invention, and thus the specific features described below are merely used to describe such embodiments to provide an overall understanding of the present invention. One skilled in the art readily recognizes that the present invention is not limited to the specific embodiments described below. Furthermore, certain descriptions of various configurations and components of the present invention that are known to one skilled in the art are omitted for the sake of clarity and brevity.

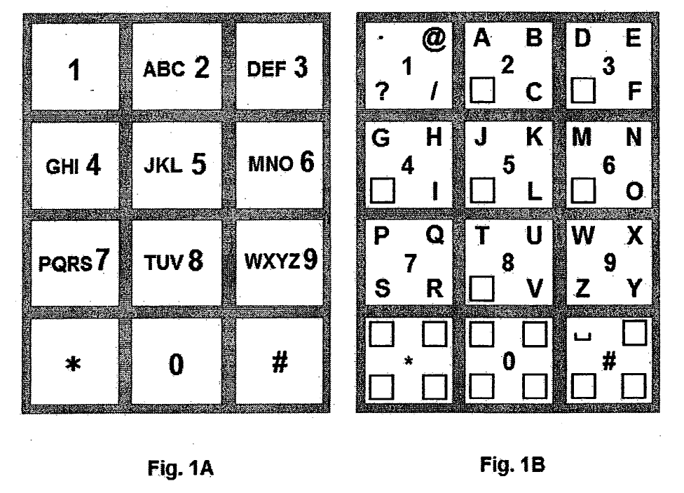

As shown in FIG. 1B, alphabets are assigned to each numeric keys from 2 to 9 as a standard format such as 2(ABC), 3(DEF), 4(GHI), 5(JKL), 6(MNO), 7(PQRS), 8(TUV), 9(WXYZ), and it is recommended to keep this key assignment for a consistency between different phone system. Some of popular symbols are also assigned to “0”, “1”, “*”, and “#” keys. As an example, FIG. 1B exemplifies best seller handset, Sanyo-8100 from Sprint PCS, which is shown in FIG. 1. Single tact switch is located underneath each key to activate each key press of the 12-key (0˜9,*,#) for standard phones.

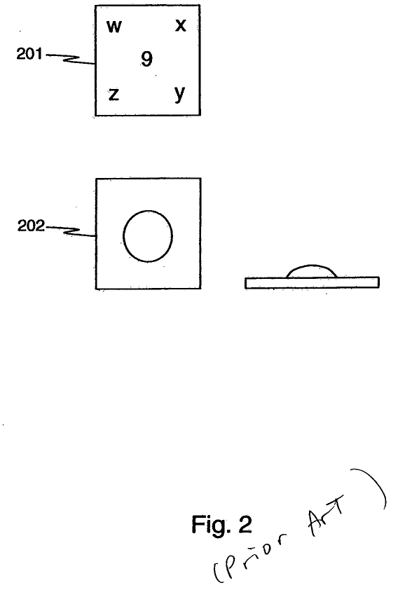

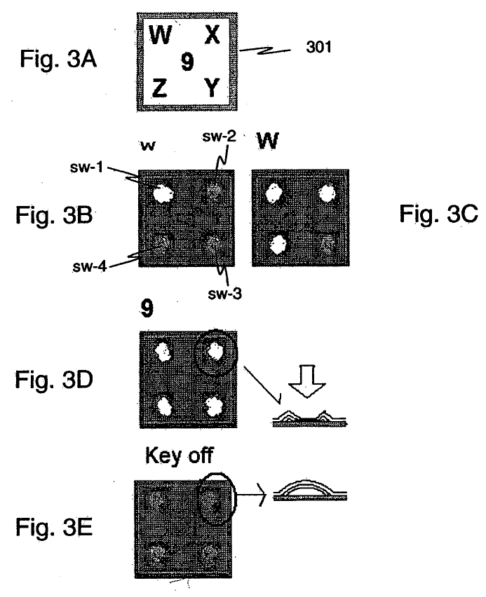

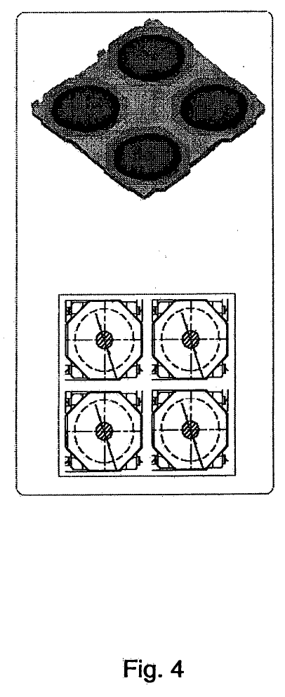

FIGS. 3A to 3E show a key of a mobile phone according to one embodiment of the present invention. As an example, similar to a conventional device key shown in FIG. 2, a number “9” and letters “W”, “X”, “Y”, and “Z” are silk printed on the key-top 301 of a key. “W” is printed on the upper left corner, “X” is printed on the upper right corner, “Y” is printed on the lower right corner, “Z” is printed on the lower left corner, and “9” is printed on its center. Four, instead of one, dome switches sw-1 to sw-4 are mounted on the printed circuit board under the key-top, at positions corresponding to each of the letters W, X, Y, and Z, respectfully. By each corner of this “9” key as shown in FIG. 3B, corresponding tact switch elements such as sw-1 (upper left), sw-2 (upper right), sw-3 (lower right), and sw-4 (lower left) will be activated. Table 1 shows how said key driver software converts key-pressed position to OUTPUT data. This new type of tact switch is small enough to replace existing single tact switch.

Different combinations of the dome switches represent different inputs. For example, in FIGS. 3B, 3C and 3D, pressing the dome switch sw-1 alone represents the letter “w” in lower case, pressing the dome switches sw-1, sw-2 and sw-3 together represents the letter “W” in upper case, and pressing the dome switches sw-1 to sw-4 together represents the number 9. Further details will be described below.

In one embodiment, a switch, type number SKRW, produced by ALPS Electric Co., Ltd. is used as the dome switch in FIGS. 3A-3E. As shown in FIG. 4, four SKRW switches are mounted on the printed circuit board under one key-top.

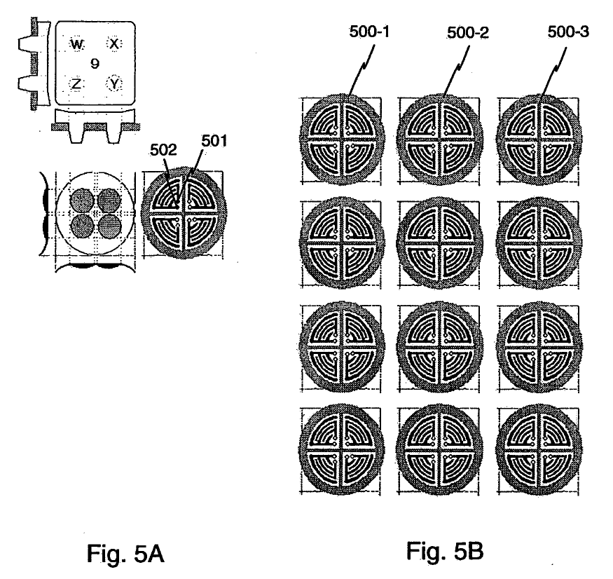

In another embodiment, a Frisbee-shaped metal switch with four round dent points is glued under the film under a key-top, as shown in FIGS. 5A and 5B. A PCB receptacle switch is divided into four sections.

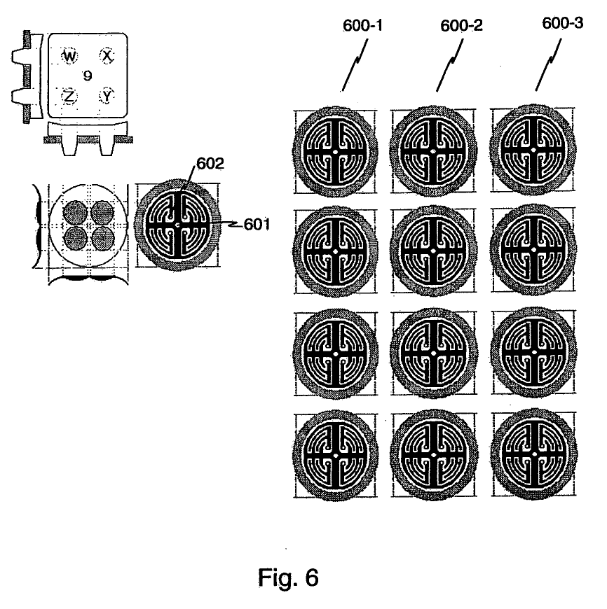

In the embodiment shown in FIGS. 5A and 5B, signal lines for the switches 500-1, 500-2, 500-3, etc, are separated. Each key has four key-out signal lines 501 and four key-in signal lines 502. In the embodiment shown in FIG. 6, the key-out signal lines for the switches 600-1, 600-2, 600-3, etc, are combined as one signal line. Each key has one key-out signal line 601 and four key-in signal lines 602.

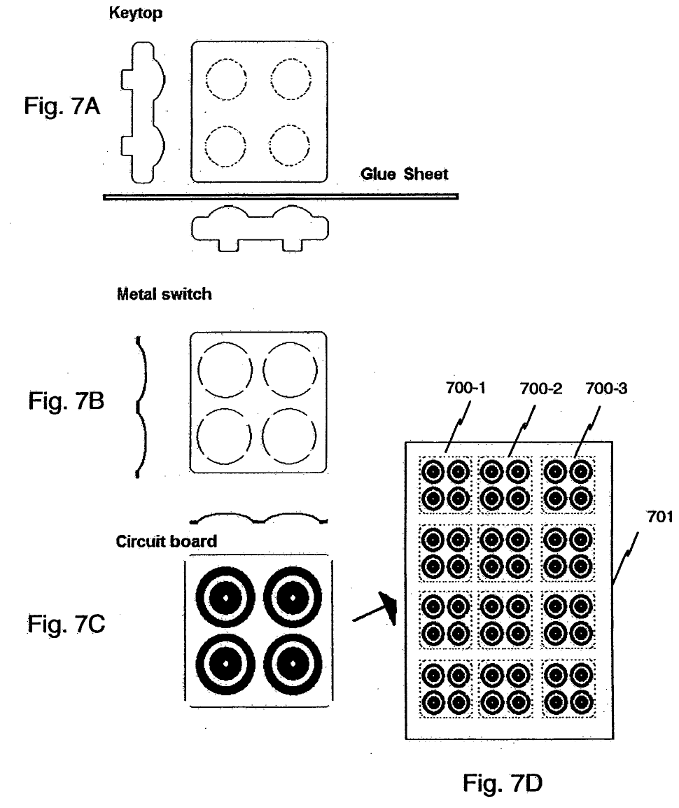

In the embodiment shown in FIGS. 7A-7D, the key-out signal lines for the switches are separated. FIG. 7D shows a sheet for manufacturing keys. As shown, a number of switch sets 700-1, 700-2, 700-3, etc, are mounted on substrate 701.

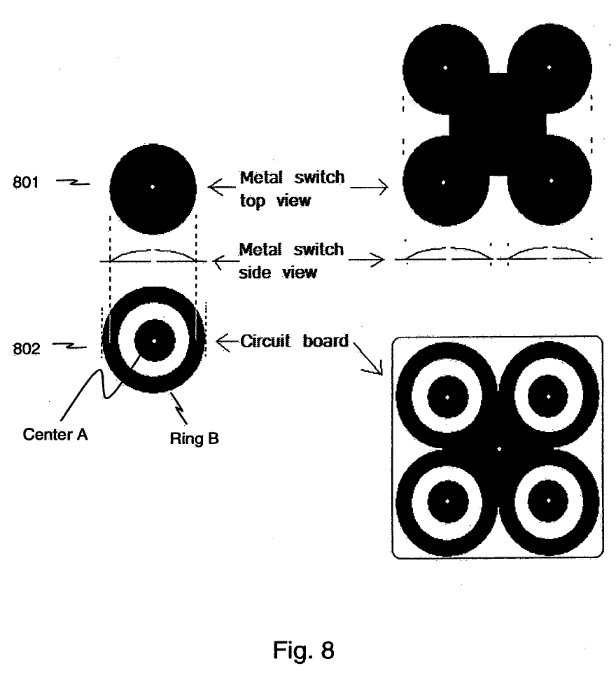

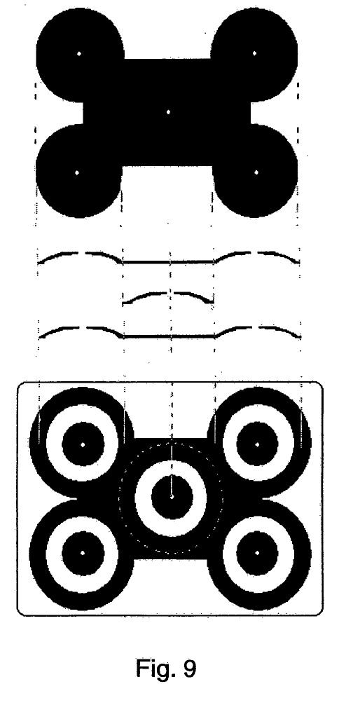

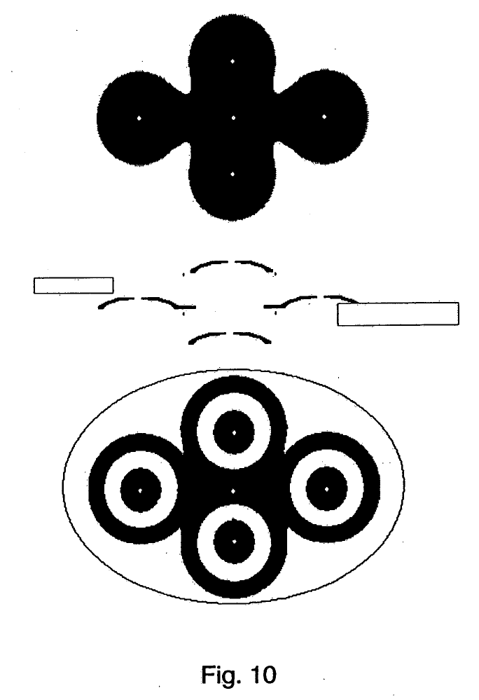

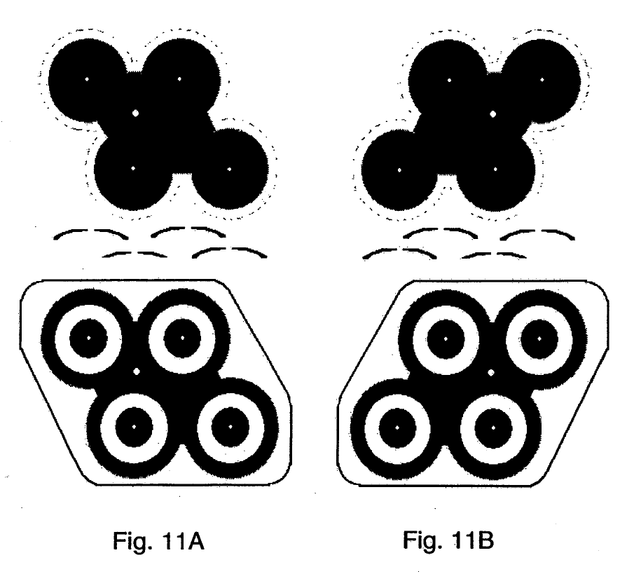

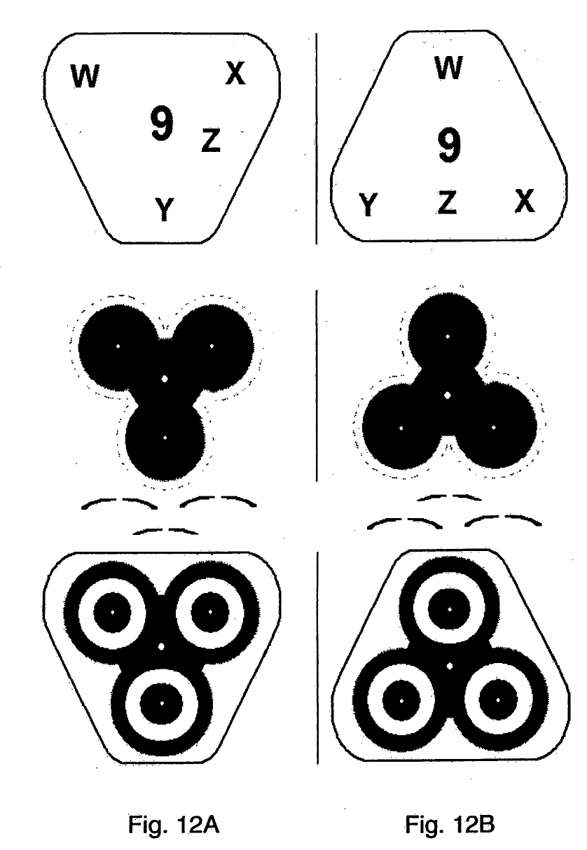

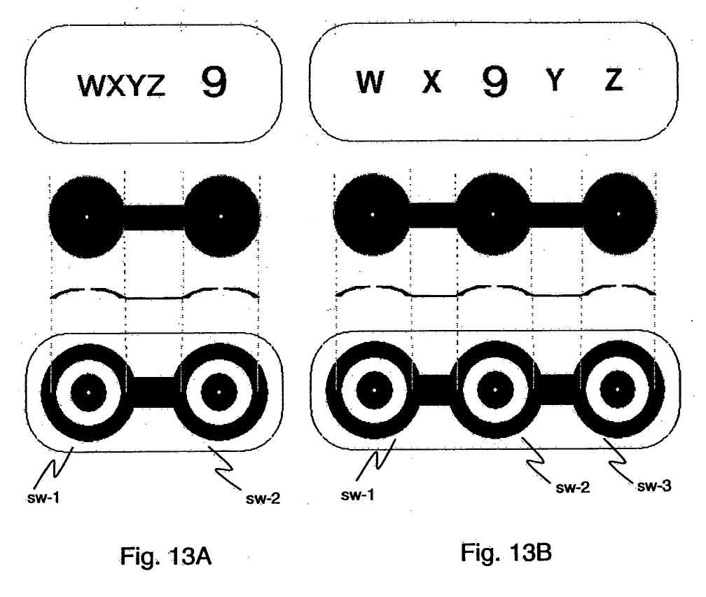

FIG. 8 shows a key according to another embodiment of the present invention. The key-top is a square and four dome switches are placed corresponding to four corners of the square. The circuit board 802 of a switch has an insulated center A and a ring B. A metal switch 801 is in the shape of a dome. Usually, the bottom periphery of the metal switch 801 contacts the ring B of the circuit board 802, but the top of the metal switch 801 is away from the switch board 802. When a user presses the key-top, the top of the metal switch 801 contacts the center A of circuit board 802, turning the switch on.

FIG. 9 shows another embodiment of the key of the present invention. The key-top is a rectangular and five dome switches are placed corresponding to four corners of the rectangular and the center, It is easier for a user to target the separate switches of the key. This design also helps to avoid the difficulty of pressing all four corner switches simultaneously when the key-top is soft. When the center switch is pressed, the effect is the same as pressing all four corner switches together.

FIGS. 10-13 show additional embodiments of the key of the present invention. FIG. 10 shows an oval key with four switches. FIGS. 11A and 11B show rhombus-shaped keys, each with four switches. FIGS. 12A and 12B show triangle shaped keys, each with three switches. FIG. 13A shows a line-shaped key with two switches, and 13B shows a line-shaped key with three switches, it should be understood that the key could be in other shapes, and the number of switches could be more or less. For example, for the “#” key shown in FIG. 1, only two switches are needed.

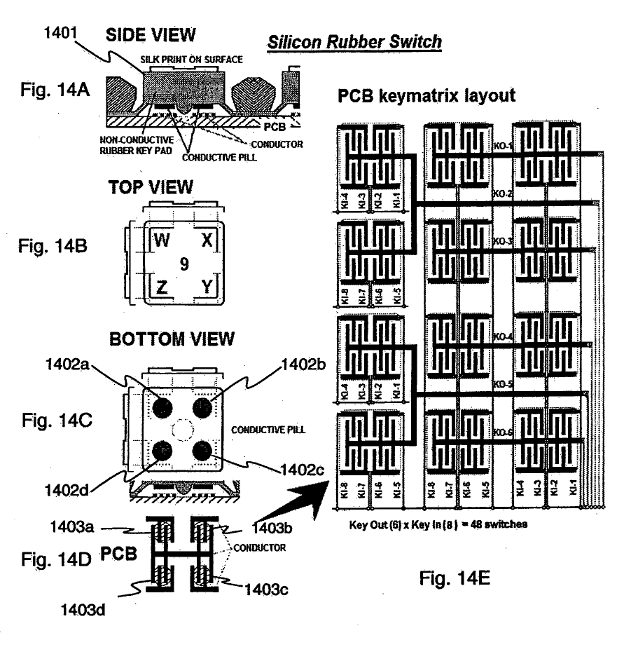

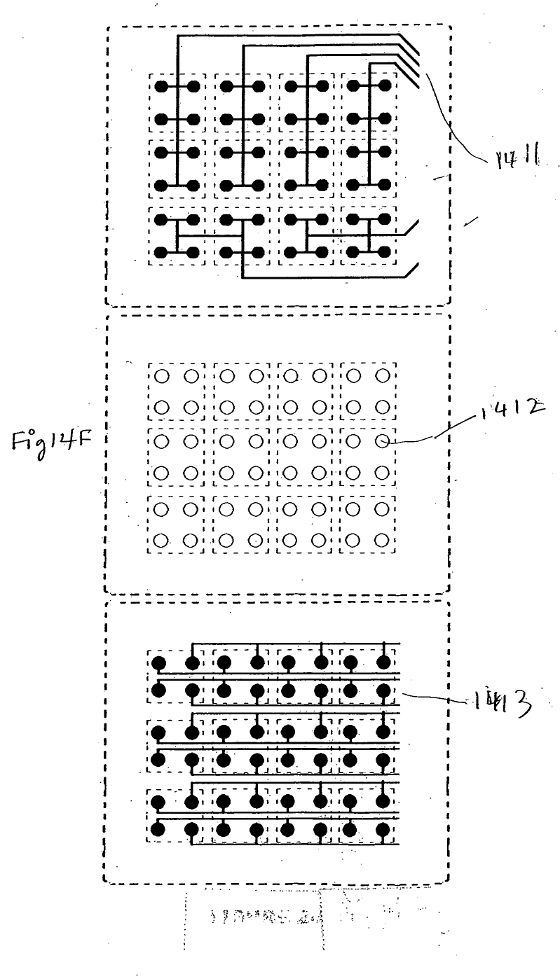

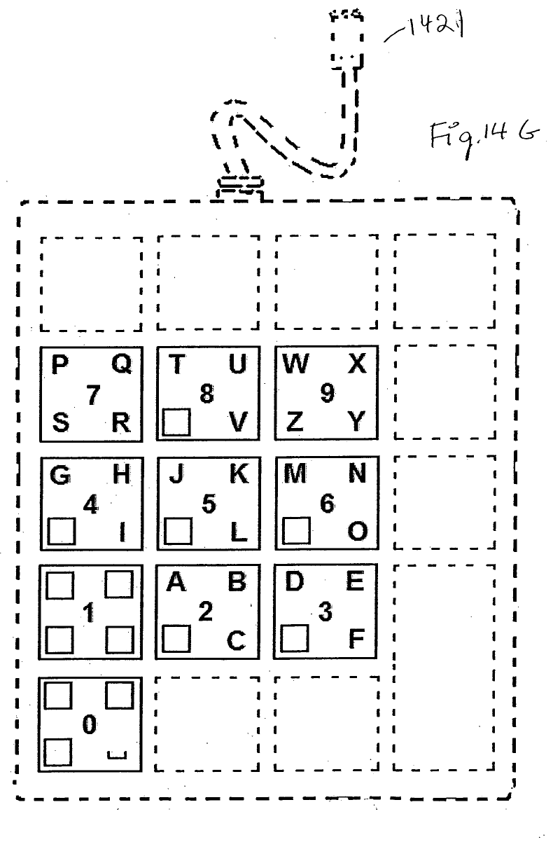

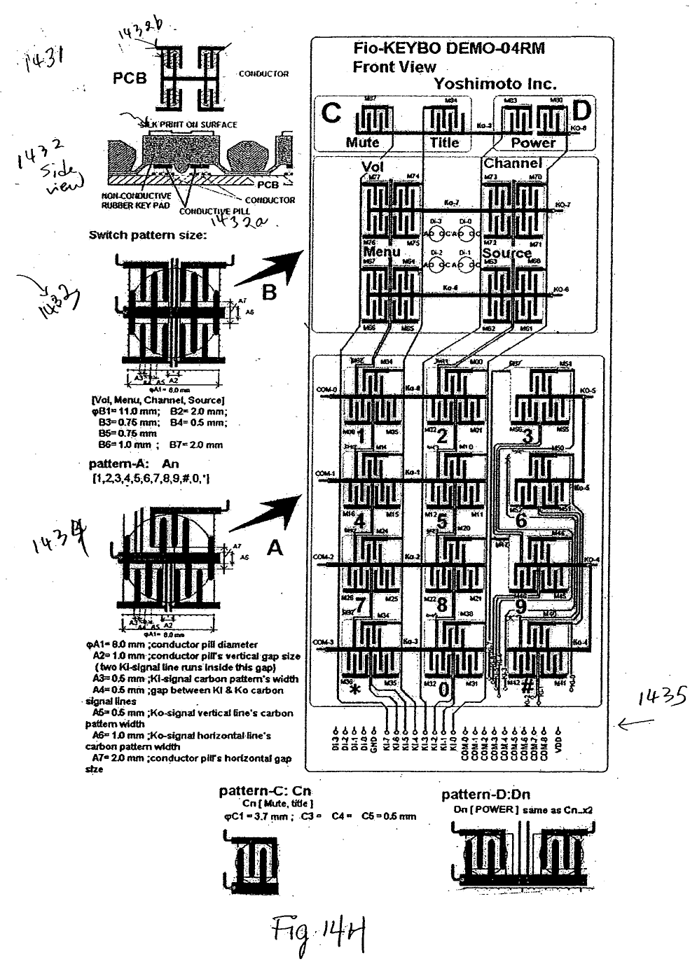

Although switches in these embodiments are shown as dome switches, other switches turned on and off by user press could be used. In the key shown in FIGS. 14A to 14C, the number 9 and letters W, X, Y, and Z are printed on the surface of a non-conductive rubber key-top 1401. Four conductive pills 1402a to 1402d are placed on the bottom of the key-top. When a part of the key-top is pressed by a user, the corresponding conductive pill(s) contact(s) one or more conductor(s) 1403a to 1403d on the PCB in FIG. 14D to turn on the switch(es). Such a low cost silicon rubber switch can be used for low-end cellular phones, or remote controllers for consumer electronics to achieve fast input. FIG. 14E illustrates a key scan matrix on a printed circuit board.

Alternatively, a thin film switch can also be used according to a specific embodiment. As illustrated in the simplified diagram of FIG. 14F, for example, a controller device comprises a thickness of material (e.g., insulator), which is a continuous sheet and/or film of material, including a plurality of thin film holes 1412 (and or recessed regions) sandwiched between a lower connect region and an upper connect region. The upper connect region includes at least a common signal line 1411 for key out and the lower connect region has a key in signal line 1413. The common signal line is coupled to an output 1421 on the control device as shown in FIG. 14G. A thin pin shaped bump is formed under a key-top. The thin pin shaped bump makes contact through the thin film hole. That is, once the key is depressed, the pin shaped bump, which is not connected to the key in signal line, moves toward the key in signal line and makes contact with it giving electrical connection between the key in signal line and the key out signal line for the key being depressed.

In a specific embodiment, the pin is separated between the two regions using the thickness of material, which can defect upon depression of the key. Alternatively, the key can also flex to allow the pin to make contact with the signal line. Of course, there can be other variations, modifications, and alternatives.

In a key-top shown in 1431-1434 in FIG. 14H, four conductive pills 1432 a (two shown) are placed on the bottom of a key top, which is one of a plurality of key tops in the key board arrangement. When a part of a key top is pressed, the corresponding part of the switch will be in contact with one or more of conducting parts on printed circuit 1431a. Such thin film switch can be used for a remote control where a user can use a single hand to generate text using a numeric keypad. Also shown in FIG. 14H, a key scan matrix on a printed circuit board 1435 for a remote control is illustrated. As merely examples, different switch patterns/size can be used for numeric keys 1434, different function keys 1432 (e.g., volume, channels, menu, source), and others.

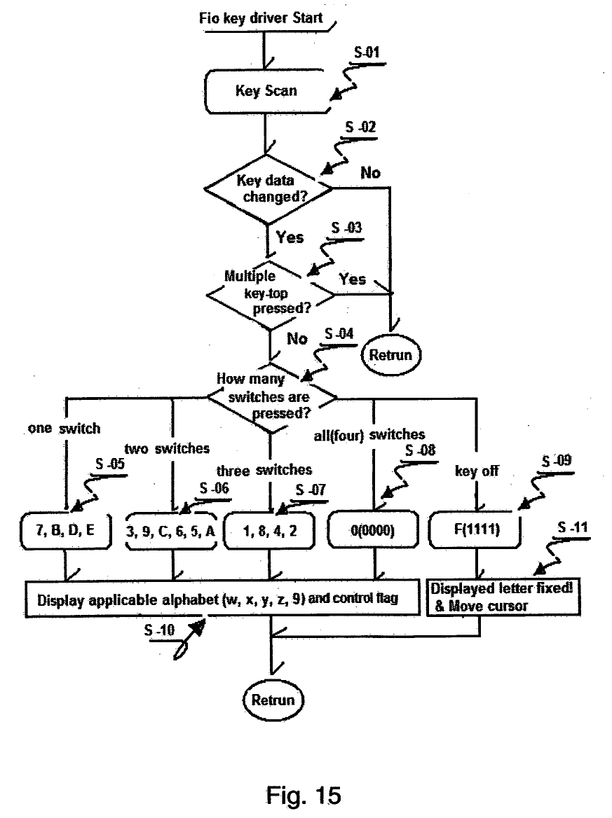

FIG. 15 shows a flowchart for controlling data input of a key with the key-top assignment of FIG. 113 according to one embodiment of the present application. Alphabetic characters are assigned to each of the numeric keys from 2 to 9 based on industrial standard such as 2(ABC), 3(DEF), 4(GHI), 5(JKL), 6(1VINO), 7(PQRS), 8(TUV), and 9(WXYZ). Symbols and other functions are also assignable to numeric keys “0” and “1”, and function keys “*” and “#”. Corners on the keys with the square shape symbol in FIG. 1B are available for future assignments. Single tact switch is located underneath each silk printed corner to activate each key press of the 12-keys (0˜9,*,#) on standard phones. In a specific embodiment, the printing occurs using a stencil, which allows for ink to be provided within the exposed regions of the stencil. Of course, thee can be other variations, modifications, and alternatives.

Referring to FIG. 15, the software starts key scan at step S-01. Twelve key-tops shown in FIG. 1B require 48 (4×12) switches, and a key-out and key-in matrix is used to minimize the number of necessary signal ports. A matrix with at least 14 signal ports, including six key-out signal ports and eight key-in signal ports, is necessary. A former “new key state” will be changed to “old key state”, and scanned data will be converted into “new key state” after each scan. If there is no key data change at step S-02, which means all key data are the same as the previous key scan, then the process returns to the main flow. If there is a key data change after a scan, then the process checks whether multiple key-tops are pressed at step S-03. If more than two different key-tops are pressed, the process ignores the scan and returns to the main flow. These steps prevent unintended key presses, such as an unintended neighbor key-top touching. This flow does not enable simultaneous multiple key-top press. Depending on how many switches are pressed at step s-04, the process proceeds to steps s-05 to s-09 respectively. The statuses of sw-1 to sw-4, with ON(0), OFF(1), are converted to corresponding key states 0(0000)-F(1111). At step S-10, applicable alphabetic characters and control flags are displayed. At step S-11, the displayed letters are fixed and the cursor on the screen of the device moves to the next position.

When an output is not case sensitive, Table 1 shows a conversion table for the key number “9”, as shown in FIGS. 1B, 2, and 3A, according to one embodiment of the present invention. When a user tries to press a corner of the key, he/she may accidentally activate two or more, instead of only one, switches. The table shown can be used to avoid an uncertain status in such an instance.

TABLE 1

| silk print | | | | | | | | | | | | | | | | | | | | |
|---|---|---|---|---|---|---|---|---|---|---|---|---|---|---|---|---|---|---|---|---|
| old key | W | X | Y | Z | new key state (O^{˜}F Displayed key value (w, x, y, z, 9) | | | | | | | | | | | | | | | |
| state | SW-1 | SW-2 | SW-3 | SW-4 | F | 7 | B | D | E | 3 | 9 | c | 6 | 5 | A | 1 | 8 | 4 | 2 | O |
| F(1111) | — | — | — | — | off | w | x | y | z | w | x | y | z | 9 | 9 | x | y | z | w | 9 |
| 7(0111) | On | — | — | — | w | w | x | y | z | w | x | y | z | 9 | 9 | x | y | z | w | 9 |
| B(1011) | — | On | — | — | x | w | x | y | z | w | x | y | z | 9 | 9 | x | y | z | w | 9 |
| D(1101) | — | — | On | — | y | w | x | y | z | w | x | y | z | 9 | 9 | x | y | z | w | 9 |
| E(1110) | — | — | — | On | z | w | x | y | z | w | x | y | z | 9 | 9 | x | y | z | w | 9 |
| 3(0011) | On | On | — | — | w | w | x | y | z | w | x | y | z | 9 | 9 | x | y | z | w | 9 |
| 9(1001) | — | On | On | — | x | w | x | y | z | w | x | y | z | 9 | 9 | x | y | z | w | 9 |
| C(1100) | — | — | On | On | y | w | x | y | z | w | x | y | z | 9 | 9 | x | y | z | w | 9 |
| 6(0110) | On | — | — | On | z | w | x | y | z | w | x | y | z | 9 | 9 | x | y | z | w | 9 |
| 5(0101) | — | On | — | On | 9 | w | x | y | z | w | x | y | z | 9 | 9 | x | y | z | w | 9 |
| A(1010) | On | — | On | — | 9 | w | x | y | z | w | x | y | z | 9 | 9 | x | y | z | w | 9 |
| 1(0001) | On | On | On | — | x | w | x | y | z | w | x | y | z | 9 | 9 | x | y | z | w | 9 |
| 8(1000) | — | On | On | On | y | w | x | y | z | w | x | y | z | 9 | 9 | x | y | z | w | 9 |
| 4(0100) | On | — | On | On | z | w | x | y | z | w | x | y | z | 9 | 9 | x | y | z | w | 9 |
| 2(0010) | On | On | — | On | w | w | x | y | z | w | x | y | z | 9 | 9 | x | y | z | w | 9 |
| 0(0000) | On | On | On | On | 9 | w | x | y | z | w | x | y | z | 9 | 9 | x | y | z | w | 9 |

* finalize the displayed key value when key has been released (off)

In one embodiment, a pre-set data table, such as Table 1, in ROM is copied to and saved in the RAM of a handheld electrical device. The key shown in FIG. 1B has four switches, and thus 16 states, from 0000 to 1111. In the key state matrix data of Table 1 shows the old key states in the first column, and the new key states in the second line. Totally, there are 256 combinations. The row identified by F(1111) contains the key states before a user presses the key-top for the first time. The user will look at a display device to find out which switch is actually activated. The display device could be the main display device of the handheld electrical device, or could be a display device used specifically for displaying the activation of the switches. The key state will be confirmed when the user releases his/her finger from the key-top.

As shown, when only one switch sw-1, sw-2, sw-3 or sw-4 of the key “9” is pressed, the new key state is “w”, “x”, “y”, or “z” respectfully at step S-05 in FIG. 15. In this case, “new key status” will be specified with no effect from “old key status”. The output for key “9” is summarized below:
Only sw-1 of key “9” is pressed: 7(0111) - - - >then, new key state is “w”
Only sw-2 of key “9” is pressed: B(1011) - - - >then, new key state is “x”
Only sw-3 of key “9” is pressed: D(1101) - - - >then, new key state is “y”
Only sw-4 of key “9” is pressed: E(1110) - - - >then, new key state is “z”

Referring again to FIG. 15. At step S-06, two switch elements are pressed. One solution is to ignore this status by setting the output as “unknown” all the time. Other solution is to deduce “new key status” by considering “old key status”. Table 1 shows an example for key “9”. When switches sw-1 and sw-2 are pressed simultaneously, the letter “w”, corresponding to the switch sw-1, is set up as the new key state at step S-06. Similarly, when switches sw-2 and sw-3 are pressed simultaneously, the letter “x”, corresponding to the switch sw-2, is set up as the new key state. When switches sw-3 and sw-4 are pressed simultaneously, the letter “y”, corresponding to the switch sw-3, is set up as the new key state. When switches sw-4 and sw-1 are pressed simultaneously, the letter “z”, corresponding to the switch sw-4, is set up as the new key state. When diagonal switches sw-2 and sw-4, or switches sw-1 and sw-3, are pressed simultaneously, the number 9 is set up as the new key state. If old key state was F(1111) then, new key state is “unknown” which is described as “?” in Table 1 temporarily. In this case, two switch elements are pressed from key off status. Other old key state and new key state combinations are illustrated in Table 1, which will be reflected by user's intention to move around the key.

As illustrated in FIG. 15, step S-07 shows the output when three switch elements are pressed. In this case, “new key status” will be specified with no effect from “old key status”. Table 1 shows an example for key“9”. The results are summarized below:
sw-1, sw-2, sw-3 of key“9” are pressed: 1(0001) - - - >then, new key state is “x”
sw-2, sw-3, sw-4 of key“9” are pressed: 8(1000) - - - >then, new key state is “y”
sw-3, sw-4, sw-1 of key“9” are pressed: 4(0100) - - - >then, new key state is “z”
sw-4, sw-1, sw-2 of key“9” are pressed: 2(0010) - - - >then, new key state is “w”
   As shown, a vertical angle position key will be selected.

Referring to FIG. 3D, when switches sw-1, sw-2, sw-3, and sw-4 are pressed simultaneously, the number “9” is set up as the new key state at step S-08 in FIG. 15. In steps S-05 to S-08, new key status data is displayed to provide feedback to the user at step S-10.

Step S-08 shows the case when all four switch elements are pressed. In this case, “new key status” will be specified without any effect from “old key status”. Table 1 shows an example of key “9”. The result is summarized below:
sw-1, sw-2, sw-3, sw-4 of key “9” are pressed: 0(0000) - - - >then, new key state is “9”

As shown in step S-10 of FIG. 15, “new key state” will be displayed on a display device, but will not be affirmed as a final key output data until detecting the key off at S-09. Such status will be displayed as a space or blinking cursor.

Step S-09 shows when all four switch elements are released. In this case, displayed data in Table 1 is fixed as a final key output data such as “w, x, y, z, 9, unknown”, and cursor will be moved to a next letter position except “unknown” as shown at S- 11.

For keys such as “1”, “*”, “0”, “#” which alphabets are not assigned, it is possible to assign major symbols as shown in FIG. 1B. Thus, user can generate alphabet, number, and symbols with one key on-off operation.

As shown in Table 1, the software compares key transition status and recognizes the key-press status change, from an old key state in the first column of Table 1 to a new key state in the second row of Table 1, and applies the best character depending on key shape and key material. When the user moves his/her finger from the upper-left corner to upper-right corner, then switch detections may move from 7(0111) with the switch sw-1 ON to 3(0011) with the switches sw-I and sw-2 ON to B(1011) with the switch sw-2 ON. Finger rotating directions are also recognized from this table. As described above, at step S-10 of FIG. 15, applicable alphabetic characters are displayed on the screen of the phone, thus allowing flexible finger control with display feedback. The input will be determined at step S-11 after the user releases his/her finger from the key-top at step S-09. Key-off chattering time may be longer than key-in chattering time.

Referring to Table 1A, the present invention provide a method to distinguish lower case and upper case by a single key on/off action. In an alternative embodiment, user can add different operating force easily, and can convert between single switch element press and multiple switch elements press as shown in Table 1A.

TABLE 1A

| case-2 | | | | | | | | | | | | | | | | | | | | |
|---|---|---|---|---|---|---|---|---|---|---|---|---|---|---|---|---|---|---|---|---|
| (case sensitive) | | | | | question mark (?) means not valid data, and will be displayed like “_” | | | | | | | | | | | | | | | |
| silk print | W | X | Y | Z | new key state(O^{˜}F) & Display key data(W, X, Y, Z, w, x, y, z, 9, ?) | | | | | | | | | | | | | | | |
| old key state | SW-1 | SW-2 | SW-3 | SW-4 | F | 7 | B | D | E | 3 | 9 | C | 6 | 5 | A | 1 | 8 | 4 | 2 | 0 |
| F(1111) | — | — | — | — | off | w | x | y | z | ? | ? | ? | ? | 9 | 9 | X | Y | Z | W | 9 |
| 7(0111) | On | — | — | — | w | w | x | y | z | x | x | z | z | 9 | 9 | X | Y | Z | W | 9 |
| B(1011) | — | On | — | — | x | w | x | y | z | w | y | y | w | 9 | 9 | X | Y | Z | W | 9 |
| D(1101) | — | — | On | — | y | w | x | y | z | x | x | z | z | 9 | 9 | X | Y | Z | W | 9 |
| E(1110) | — | — | — | On | z | w | x | y | z | w | y | y | w | 9 | 9 | X | Y | Z | W | 9 |
| 3(0011) | On | On | — | — | w, x, 9, ? | w | x | y | z | ? | x | 9, ? | w | 9 | 9 | X | Y | Z | W | 9 |
| 9(1001) | — | On | On | — | x, y, 9, ? | w | x | y | z | x | ? | y | 9, ? | 9 | 9 | X | Y | Z | W | 9 |
| C(1100) | — | — | On | On | y, z, 9, ? | w | x | y | z | 9, ? | y | ? | z | 9 | 9 | X | Y | Z | W | 9 |
| 6(0110) | On | — | — | On | z, w, 9, ? | w | x | y | z | w | 9, ? | z | ? | 9 | 9 | X | Y | Z | W | 9 |
| 5(0101) | — | On | — | On | 9 | w | x | y | z | w | y | y | w | 9 | 9 | X | Y | Z | W | 9 |
| A(1010) | On | — | On | — | 9 | w | x | y | z | x | x | z | z | 9 | 9 | X | Y | Z | W | 9 |
| 1(0001) | On | On | On | — | X | w | x | y | z | w | y | y | w | 9 | 9 | X | Y | Z | W | 9 |
| 8(1000) | — | On | On | On | Y | w | x | y | z | x | x | z | z | 9 | 9 | X | Y | Z | W | 9 |
| 4(0100) | On | — | On | On | Z | w | x | y | z | w | y | y | w | 9 | 9 | X | Y | Z | W | 9 |
| 2(0010) | On | On | — | On | W | w | x | y | z | x | x | z | z | 9 | 9 | X | Y | Z | W | 9 |
| 0(0000) | On | On | On | On | 9 | w | x | y | z | 9, ? | 9, ? | 9, ? | 9, ? | 9 | 9 | X | Y | Z | W | 9 |

| | |
|---|---|
| FIG. O7 | * finalize the displayed key value when key has been released(off) |

When specific key's switch elements' status has been changed at S-04 in FIG. 15, it goes to step S-05 or to step S-09 depending on how many switch elements are pressed or changed. Status of sw-1˜sw-4, which ON(0), OFF(1), will be converted to 0(0000)˜F(1111) key state.

Step S-05 shows when only one switch element is pressed. In this case, “new key status” will be specified without any effect from “old key status”. Table 1 shows an example for key “9”.The results are summarized below:
Only sw-1 of key “9” is pressed: 7(0111) - - - >then, new key state is lower case “w”
Only sw-2 of key “9” is pressed: B(1011) - - - >then, new key state is lower case “x”
Only sw-3 of key “9” is pressed: D(1101) - - - >then, new key state is lower case “y”
Only sw-4 of key “9” is pressed: E(1110) - - - >then, new key state is lower case “z”

Referring to FIG. 15, Step S-06 shows when two switch elements are pressed. One solution is to ignore this status always by setting the output as “unknown”. Other solution is to deduce “new key status” by considering “old key status”. Table 1 shows an example for key“9”.

If diagonal switches sw-1 and sw-3 or sw-2 and sw-4 are pressed, the new key state is “9”. If old key state was F(1 111) then, new key state is “unknown” which is described as “?” in Table 1. In this case, two switch elements are pressed from key off status.

Other old key state and new key state combination will be described by referring to Table 1A, which will reflect user's intention to move around a finger on the key-top. When switches sw-1 and sw-2 are pressed simultaneously (via pressing a selected portion of the key top), the letter “W”, corresponding to the switch sw-1, is set up as the new key state at step S-06. Similarly, when switches sw-2 and sw-3 are pressed simultaneously via selected portion of the key top, the letter “X”, corresponding to the switch sw-2, is set up as the new key state. When switches sw-3 and sw-4 are pressed simultaneously via selected portion of the key top, the letter “Y”, corresponding to the switch sw-3, is set up as the new key state. When switches sw-4 and sw-1 are pressed simultaneously via selected portion of the keytop, the letter “Z”, corresponding to the switch sw-4, is set up as the new key state.

Referring again to FIG. 15, step S-07 shows when three switch elements are pressed. In this case, “new key status” will be specified without any effect from “old key status”. Table 1A shows an example for key “9”.The output is summarized below:
sw-1, sw-2, sw-3 of key “9” are pressed: 1(0001) - - - >then, new key state is upper case “X”
sw-2, sw-3, sw-4 of key “9” are pressed: 8(1000) - - - >then, new key state is upper case “Y”
sw-3, sw-4, sw-1 of key “9” are pressed: 4(0100) - - - >then, new key state is upper case “Z”
sw-4, sw-1, sw-2 of key “9” are pressed: 2(0010) - - - >then, new key state is upper case “W”. As illustrated, a vertical angle position key can be selected for upper case letters.

Referring to FIG. 15, step S-08 shows when all four switch elements are pressed. In this case, “new key status” will be specified without any effect from “old key status”. Table 1 shows an example for key“9”. The output is summarized below:
sw-1, sw-2, sw-3, sw-4 of key“9” are pressed: 0(0000) - - - >then, new key state is “9”

As shown in Step S-10 of FIG. 15, “new key sate” will be displayed on a display device, but will not be affirmed as a final key output data until key off at step S-09. Such status will be displayed as a space or a blinking cursor.

Step S-09 shows when all four switch elements are released. In this case, displayed data in Table 1 is fixed as final key output data such as “w”, “x”, “y”, “z”, “9”, or “unknown”, and cursor will be moved to a next letter position as shown at S-11 except when the output data is “unknown”.

For keys such as “1”, “*”, “0”, “#” where alphabets are not assigned, it is possible to assign major symbols as shown in FIG. 1B. As shown in FIG. 1B, it is possible to assign symbols for keys such as “1”, “*”, “0”, “#” where alphabetical characters are not assigned. When exceeding number of symbols are assigned for key-top such as number “1” in FIG. 1B, then rotating key press motion will convert multiple symbol data to a display device. When user release the key-top, displayed symbol will be affirmed as an input data. By moving key press clockwise and counterclockwise, user can change direction of displaying symbol data. For example: clockwise movement . . . 1>.>@>->'>,>/>;>?>(>)>CR>1> counterclockwise movement . . . 1<.<@<-<'<, </<;<?(<)<CR<1<

It is also possible to start “1”, “@”,“-”, “/” letter depends on the key pressed position of each corner. In this case, from S-04 to S-09 process as shown in FIG. 15 will detect direction either clockwise or counterclockwise based on old key state and new key state value as shown in Table 1. When a user moves around a finger on the key-top without releasing the key, it is possible to detect the direction from Table 1.

In a specific embodiment, the device according to the present invention allows users to display a sub menu without going into the sub menu. When each key-top is assigned for each menu icon on display, pressing different key position will convert a target icon to one of its sub icon menu, and releasing its key-top will cause the status either back to menu icon under single press or launch the displayed sub menu icon application under triple press. As an example, sub menu 1-4 can be displayed by converting each switch element's OUTPUT value “w”, “x”, “y”, or “z” as shown in Table 1B & FIG. 15. A 3 dimensional menu icon image can be controlled in accordance to embodiments of the present invention. A user can change the shape or design of the 3 dimensional menu icon by moving around each key-top position.

It is understood that various modifications and alternatives exist and would be obvious to one skilled in the art. For example, each of the key top configurations in as exemplified in FIGS. 8-10 can be used together with the software and algorithm described in Table 1 and Table 1A.

Table 2A shows a conversion table for keys with a triangular key-top, as shown in FIG. 12B.

TABLE 2A

| silk print | W | X | Y | new key state (07) & Displayed key value (w, x, y, z, 9) | | | | | | | |
|---|---|---|---|---|---|---|---|---|---|---|---|
| old key state | SW-1 | SW-2 | SW-3 | 7 | 3 | 5 | 6 | 1 | 4 | 2 | 0 |
| 7(111) | — | — | — | off | w | x | y | z | z | z | 9 |
| 3(011) | On | — | — | x, y, z, w, 9 | = | + | − | = | = | = | 9 |
| 5(101) | — | On | | | − | = | + | = | = | = | 9 |
| 6(110) | — | — | On | | + | − | = | = | = | = | 9 |
| 1(001) | On | On | — | | − | + | = | = | + | − | 9 |
| 4(100) | — | On | On | | = | − | + | − | = | + | 9 |
| 2(010) | On | — | On | | + | = | − | + | − | = | 9 |
| 0(000) | On | On | On | 9 | w | + | y | z | z | z | 9 |

* finalize the displayed key value when key has been released (off)

(+): Clockwise rotation w > x > y > z > w.
(−): Counter Clockwise rotation w > x > y > z > w.
(=): No value change

Initially, three switches are assigned as w, x, or y. When any two switches are pressed simultaneously, the letter z will be assigned. When all three switches are pressed simultaneously, the number 9 will always-be assigned. When a user rotates his or her finger without releasing the key-top, by detecting any clockwise movement (represented by “+” in the table), then the letters w, x, y, and z are displayed serially in a clockwise manner, i.e., w, x, y, z, and w. By detecting any counterclockwise movement (represented by “−−” in the table), the letters are displayed in a counterclockwise manner, i.e., w, z, y, x, and w.

Table 2B shows a conversion table for keys with a triangular key-top, as shown in FIG. 12B, with case sensitivity.

TABLE 2B

| silk print | W | X | Y | new key state (07) & Displayed key value (w, x, y, z, 9) | | | | | | | |
|---|---|---|---|---|---|---|---|---|---|---|---|
| old key state | SW-1 | SW-2 | SW-3 | 7 | 3 | 5 | 6 | 1 | 4 | 2 | 0 |
| 7(111) | — | — | — | off | w | x | y | w | x | y | 9 |
| 3(011) | On | — | — | x, y, z, w, 9 | = | + | − | = | = | = | Caps |
| 5(101) | — | On | | | − | = | + | = | = | = | Caps |
| 6(110) | — | — | On | | + | − | = | = | = | = | Caps |
| 1(001) | On | On | — | | − | + | = | = | + | − | Caps |
| 4(100) | — | On | On | | = | − | + | − | = | + | Caps |
| 2(010) | On | — | On | | + | = | − | + | − | = | Caps |
| 0(000) | On | On | On | | W | X | Y | W | X | Y | = |

* finalize the displayed key value when key has been released (off)

(+): Clockwise rotation w > x > y > z > w.
(−): Counter Clockwise rotation w > x > y > z > w.
(=): No value change
Caps: Change upper/Lower case

Initially, three switches are assigned as w, x, or y. When all three switches are pressed simultaneously, the number 9 is assigned. When a user rotates his or her finger without releasing the key-top, by detecting any clockwise (+) movement, the letters and the number 9 are displayed serially in a clockwise (w, x, y, z, 9, w) manner. Upon detecting counterclockwise (−) movement, the letters and the number 9 are then displayed in a counterclockwise (w, 9, z, y, x, w) manner. When a user would like to change between upper and lower case, the user can press all three keys simultaneously, then return back to the corner position for the intended letter.

The shapes, rim angle, height, and key-top surface of the key and switch material will effect the user's finger movement, and therefore the table data has a built-in degree of flexibly to change its conversion table. For example, when the keys are designed to enable easy targeting of their corners or rims with the user's finger, Table 2A could be used. When the key-tops have metal surfaces, Table 2B could be used.

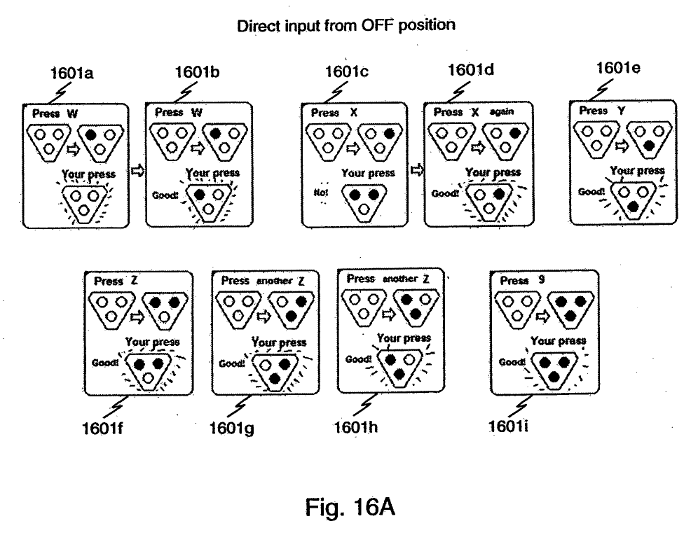

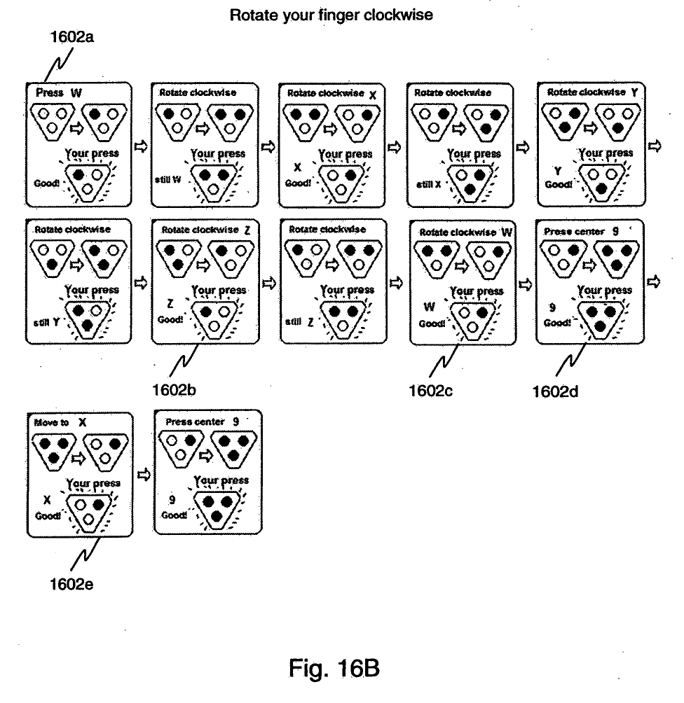

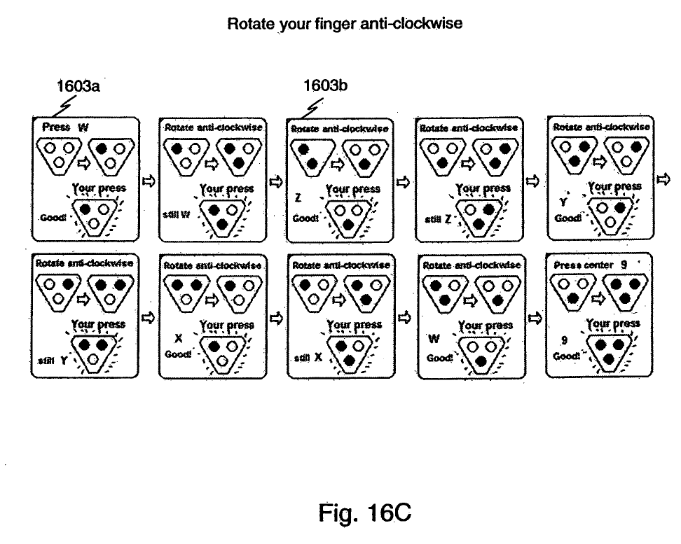

Users have the flexibility to select the input conversion table between Table 2A or Table 2B, as shown in FIGS. 16-18.

Table 3 shows a conversion table for a line-shaped key-top with three switches, as shown in FIG. 13B.

TABLE 3

| silk print | w, x, y, z, 9 | | | | | | | | | | |
|---|---|---|---|---|---|---|---|---|---|---|---|
| old key state | SW-1 | SW-2 | SW-3 | 7 | 3 | 5 | 6 | 1 | 4 | 2 | 0 |
| 7(111) | — | — | — | off | w | | z | x | y | | 9 |
| 3(011) | On | — | — | x, y, x, y | = | | f(1) | = | f(1) | | next |
| 5(101) | not possible | | | | | | | | | | |
| 6(001) | — | — | On | | f(0) | | = | f(0) | = | | next |
| 1(001) | On | On | — | | = | | f(1) | = | f(1) | | next |
| 4(100) | — | — | — | | f(0) | | = | f(0) | = | | next |
| 2(010) | — | On | On | not possible | | | | | | | |
| 0(000) | On | On | On | 9 | chk(3) | | chk(6) | = | = | | = |

* finalize the displayed key value when key has been released (off)

(next): move to the next alphabet by following the same direction
(+): Clockwise rotation w > x > y > z > w.
(−): Counter Clockwise rotation w > x > y > z > w.
(=): No value change
f(1): keep rotate & set flag(1) as a evidence that key press reached right side of key-top
f(0): keep rotate & clear flag(0) as a evidence that key press reached left side of key-top
chk(3): Change rotate direction if flag(0), then move to the next letter
chk(6): Change rotate direction if flag(1), then move to the next letter

Either w, x, y, z or 9 will be assigned in response to a user's first press, depending on the key press position such as, from the left side end to the right side end of the key-top, the key states changes from w with the switch sw-1 ON only, x with switches sw-1 and sw-2 ON, 9 with switches sw-1 and sw-2 and sw-3 ON, y with switches sw-2 and sw-3 ON, and z with switch sw-3 ON.

It may not be possible to press the switch sw-2 only or the switches sw-1 and sw-3 together, depending on the key-top material and the width of the key-top. The user will release his/her finger immediately if the intended letter has been displayed, If not, the user moves his or her finger left and right in a rotational pattern to show the desired letters or numerals on a screen.

The rotation direction can be changed easily. A direction flag is set depending on the position of the finger. The user needs to pass his or her finger over the center position of the key-top to display the next letter. The rotating direction can be changed when the user moves back his or her finger before crossing the center. When the user skips over an intended letter, he/she can simply move back his or her finger before crossing the center. Then the rotating direction will change and intended letter will be displayed immediately. This method is very useful, especially for symbol selection, particularly since over 10 symbols can be assigned to the key number 1.

TABLE 4

| silk print | w, x, y, z, 9 | | new key state (0, 1, 2, 3,) & Displayed key value (w, x, y, z, 9) | | | |
|---|---|---|---|---|---|---|
| old key state | SW-1 | SW-2 | 3 | 1 | 2 | 0 |
| 3(11) | — | — | off | w, flag(0) | z, flag(1) | 9, flag(1) |
| 1(01) | On | — | x, y, z, w, 9 | = | next | invert flag |
| 2(10) | — | On | | next | = | invert flag |
| 0(00) | On | On | | chk(1) | chk(2) | = |

* finalize the displayed key value when key has been released (off)

next: move to the next alphabet by following the same direction
(+): Clockwise rotation w > x > y > z > w
(−): Counter Clockwise rotation w > x > y > z > w
(=): No value change
f(1): keep rotate & set flag(1) as a evidence that key press reached right side of key-top
f(0): kep rotate & clear flag(0) as a evidence that key press reached left side of key-top
chk(1): Change rotate direction if flag(1), then clear as flag(0) and move to the next letter
:If flag (0), then move to the next letter (no rotation)
chk(2): Change rotate direction if flag(0), then set as flag(1) and move the next letter
:If flag(1), then move to the next letter (no rotation)

Table 4 shows a conversion table for a line-shaped key-top with two switches, as shown in FIG. 13A. When a user presses the left side end of the key-top, the letter w is assigned. If the right side end is pressed, the letter z is assigned. If the user presses the center of the key-top, then the number 9 is assigned. To cause the letter y or x to be displayed, the user moves his or her finger from left to right or from right to left. Although this embodiment has only two switches, it drastically increases the speed of character input. The user can also rotate through letters in both directions by simply rotating his or her finger in the opposite direction before reaching the other end.

Additionally, the switches of the present invention can also be applied to conventional standard multi-tap solutions.

Instead of detecting key release timing, the method of the present invention can simply adopt key on timing. Applying the multi-tap method to the switches of the present invention may put limits on the methods explained above, but the direction change capability can be kept. For the two switch solution shown in FIG. 13A, the user can select three direct inputs such as w, z, and 9 initially. Then the left side switch sw-1 is only used for clockwise rotation, so that w, x, y, z, 9, and w will be displayed serially when the user presses the left side of the key within a specific time period, such as 2 seconds. Similarly, the right side switch sw-2 is used for counterclockwise rotation only, so that z, y, x, w, 9 and z will be displayed serially. This can facilitate the data input when it is difficult for the user to move his/her finger.

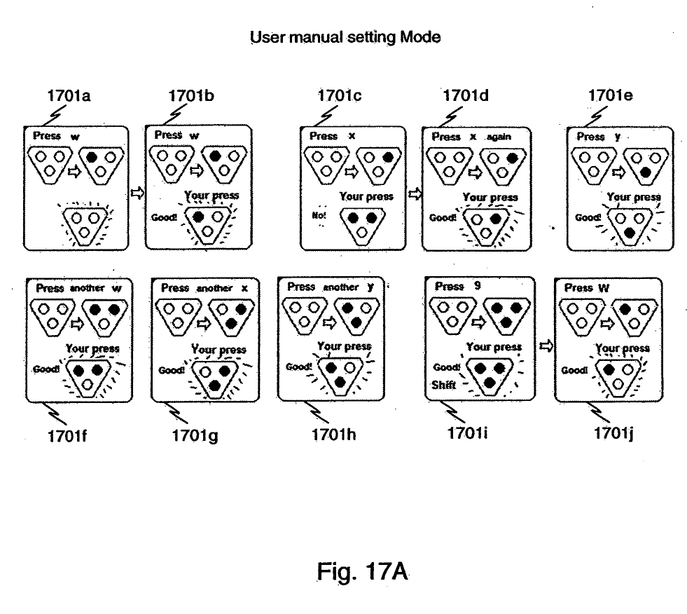

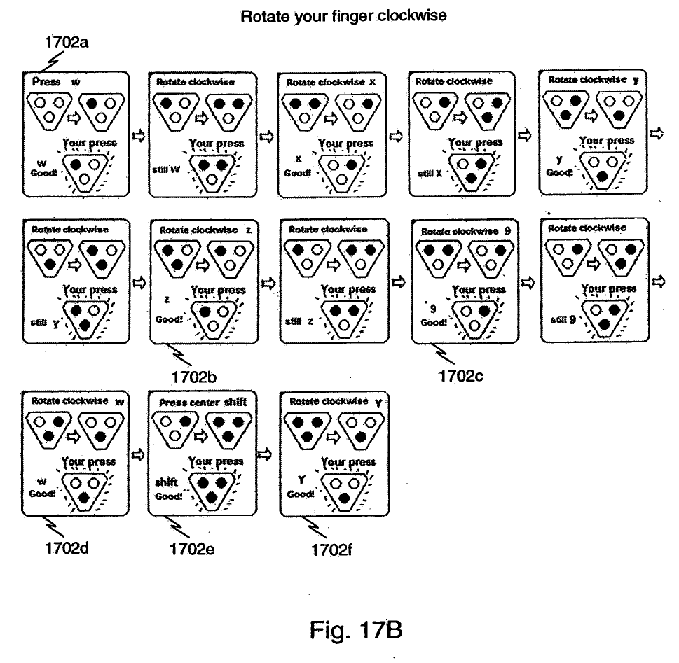

FIGS. 16A-16C show a tutorial model based on one input conversion table according to one embodiment of the present invention. FIGS. 17A and 17B show a tutorial model based on another input conversion table according to another embodiment of the present invention. As shown, the user activates the same switches at 1602c and 1702c. but the outputs are “W” and “9” respectively. Depending on which conversion table fits his/her habits better, the user can select one of the input conversion tables as the one to be used.

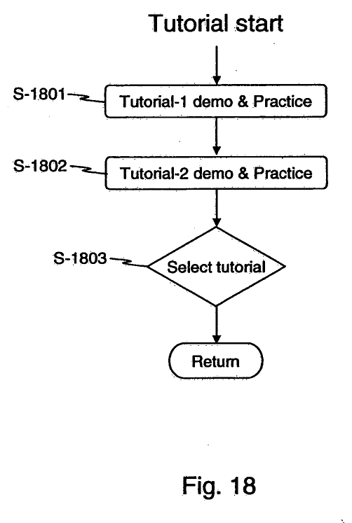

FIG. 18 shows a flowchart for selecting an input conversion table according to one embodiment of the present application. As shown, the user tries the tutorial models at steps s-1801 and s1802, and selects the one he/she likes at step 1803.

Although the invention is described above with reference to a key arrangement of a mobile phone, the invention can be used in other handheld electrical devices, such as remote controllers, cordless phones, combination telephone recorders, smart-phones and PDAs, and even as a single-hand use assistive PC keyboard. The invention can also be used in other electrical devices, such as fax machines and remote controllers. The remote controllers can be of a type used to control any type of electronic device, including audio and video equipment, PCs, TIVO devices, or game consoles. On a game console, for example, a user can move/rotate an target object and assign an action to the target object simultaneously according to a specific embodiment. For example, if key “4” and key “6” are assigned for a left and a right movement for an object in a game respectively, key “0” can be assigned to an action such as shooting. There can also be other alternatives that would be recognized by one of ordinary skill in the art.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

What is claimed is:

1. A data entry device comprising:
a key-top with at least a first symbol on its surface;
a first switch, activated when a first part of the key-top is pressed;
a second switch, activated when a second part of the key-top is pressed; and
conversion means having inputs coupled to said first and second switches, said conversion means producing an output having states unique to respective combinations of activation states of said first and second switches including simultaneous activation.

2. The data entry device of claim 1, further comprising a third switch activated when a third part of the key-top is pressed, said conversion means further having an input coupled to said third switch, said conversion means producing an output having states unique to respective combinations of activation states of said first, second and third switches including simultaneous activation of two or more of said switches.

3. The data entry device of claim 2, wherein the key-top is a triangle and the said first, second and third switches are placed corresponding to the three corners of the triangle.

4. The data entry device of claim 2, further comprising a fourth switch activated when a fourth part of the key-top is pressed, said conversion means further having an input coupled to said fourth switch, said conversion means producing an output having states unique to respective combinations of activation states of said first, second, third and fourth switches including simultaneous activation of two or more of said switches.

5. The data entry device of claim 4, wherein the key-top is a square and the first, second, third and fourth switches are placed corresponding to the four corners of the square.

6. The data entry device of claim 4, wherein the key-top is a rectangular and the first, second, third and fourth switches are placed corresponding to the four corners of the rectangular.

7. The data entry device of claim 4, wherein the key-top is a rhombus and the first, second, third and fourth switches are placed substantially within the rhombus.

8. The data entry device of claim 4, wherein the key-top is an oval and the first, second, third and fourth switches are placed substantially within the oval.

9. The data entry device of claim 4, further comprising a fifth switch activated when a fifth part of the key-top is pressed, said conversion means further having an input coupled to said fifth switch, said conversion means producing an output having states unique to respective combinations of activation states of said first, second, third, fourth and fifth switches including simultaneous activation of two or more of said switches.

10. The data entry device of claim 9, wherein the fifth switch is surrounded by the first, second, third and fourth switches.

11. The data entry device of claim 1, wherein the key-top is linearly shaped and the first and second switches are arranged in a line.

12. The data entry device of claim 2, wherein the key-top is linearly shaped and the first, second and third switches are arranged in a line.

13. The data entry device of claim 1, wherein the first symbol corresponds to the first part of the key-top.

14. The data entry device of claim 1, wherein at least one of the switches is a dome switch.

15. The data entry device of claim 14, wherein the dome switch comprises:
a dome-shaped metal switch; and a circuit board comprising an center and an outer ring insulated from each other,
wherein the outer ring contacts the bottom periphery of the dome-shaped metal switch constantly, and the center is connected to the top of the dome when the key-top is pressed.

16. The data entry device of claim 1, wherein the key-top is made of non-conductive rubber,

17. The data entry device of claim 16, further comprising at least two conductive pills at the bottom of the key-top, the first conductive pill corresponding to the first part of the key-top and the second conductive pill corresponding to the second part of the key-top.

18. The data entry device of claim 17, further comprising a circuit board having at least two conductors, wherein the first conductor contacts the first conductive pill when the first part of the key-top is pressed.

19. The data entry device of claim 1, wherein the output of the data entry device rotates in a direction determined in accordance with the status of the switches effected by a user's input.

20. The data entry device of claim 19, wherein the output of the data entry device can be selected according to the user's preference.

21. The data entry device of claim 1, wherein said conversion means comprises a memory having a conversion table stored therein.

22. The data entry device of claim 1, wherein said conversion means comprises software means for converting activation states of said first and second switches to said output of said conversion means.

23. A keypad comprising a plurality of data entry devices, each of said data entry devices comprising:
a key-top with at least a first symbol on its surface;
a first switch, activated when a first part of the key-top is pressed;
a second switch, activated when a second part of the key-top is pressed; and
a memory device having a conversion table stored therein and having inputs coupled to said first and second switches, said memory device producing an output having states
unique to respective combinations of activation states of said first and second switches including simultaneous activation.

24. An electrical device comprising:
a keypad comprising a plurality of data entry devices, each of said data entry devices comprising:
a key-top with at least a first symbol on its surface;
a first switch, activated when a first part of the key-top is pressed;
a second switch, activated when a second part of the key-top is pressed; and
a memory device having a conversion table stored therein and having inputs coupled to said first and second switches, said memory device producing an output having states unique to respective combinations of activation states of said first and second switches including simultaneous activation; and
a control device for controlling predetermined operations of said electrical device in response to said output of said memory device.

25. The electrical device of claim 24, wherein said electrical device is a mobile telephone, a smart phone, a remote controller, a PDA, or a cordless phone.

26. The electrical device of claim 24, wherein said keypad is designed for facilitating single-hand use.

27. A data entry method comprising:
activating a first switch to provide a first output when a first part of a key-top is pressed;
activating a second switch to provide a second output when a second part of the key-top is pressed; and
providing a first predetermined output according to a stored conversion table when the first and second switches are activated simultaneously.

28. The data entry method of claim27, wherein the first predetermined output is neither the first output nor the second output.

29. The data entry method of claim 27, further comprising: activating a third switch to provide a third output when a third part of the key-top is pressed.

30. The data entry method of claim 29, further comprising: providing a fourth predetermined output when the first, second and third switches are activated simultaneously.

31. The data entry method of claim 30, wherein the fourth predetermined output is none of the first, second or third output.

32. The data entry method of claim 29, further comprising: activating a fourth switch to provide a fourth output when a fourth part of the key-top is pressed.

33. The data entry method of claim 32, further comprising: providing a fifth predetermined output when the first, second, third and fourth switches are activated simultaneously.

34. The data entry method of claim 33, wherein the fifth predetermined output is none of the first, second, third or fourth output.

35. The data entry method of claim 29, further comprising: displaying the first, second and third outputs serially when a user rotates his/her finger on the key-top.

36. The data entry method of claim 35, wherein the first, second and third outputs are displayed serially in a clockwise manner on a display device when the user rotates his/her finger on the key-top in a clockwise direction.

37. The data entry method of claim 27, further comprising: providing the upper case of the first output when the user first presses three parts of the key-top together, and then presses the first part of the key-top.

38. The data entry method of claim 33, further comprising: providing a sixth predetermined output when a user moves his/her finger along a first direction.

39. The data entry method of claim 38, further comprising: providing a seventh predetermined output when the user moves his/her forger along a second direction.

40. The data entry method of claim 37, further comprising: displaying all possible outputs related to the key-top serially on a display device when a user keeps pressing one of the first and second switches for a predetermined period of time.

41. The data entry method of claim 40, further comprising: displaying the possible outputs in a first rotational direction when the first switch is pressed.

42. A computer program product containing program code for performing the method according to claim 27.

43. A computer program product containing program code for performing the method according to claim 28.

44. A computer program product containing program code for performing the method according to claim 34.

45. A method for controlling a data entry device comprising:
providing a plurality of data entry devices, each of said data entry devices comprising a key-top with at least a first symbol on its surface, and a plurality of switches mounted
adjacent said key-top, one or more of said switches being activated when corresponding parts of said key-top are pressed;
arranging said switches of said plurality of data entry devices in a matrix;
scanning said matrix to determine whether a pressing state of any of said key pads has changed;
determining which of said switches are being pressed if a pressing state has changed;
determining an output state according to the switches being pressed.

46. The method of claim 45, further comprising: displaying an indication of said output on a display device.

47. The method of claim 46, further comprising: determining an output when a user releases the key-top.

48. A sheet for manufacturing keys, comprising: a substrate; and a plurality sets of switches mounted on the substrate,
wherein each set of switch is arranged according to the shape of a key-top and comprises at least two switches, the first switch is activated when a first part of the key-top is pressed, the second switch is activated when a second part of the key-top is pressed, and both the first switch and the second switch are activated when a third part of the key-top is pressed.

49. A data entry device comprising:
a key-top with at least a first symbol on its surface;
a first switch, activated when a first part of the key-top is pressed;
a second switch, activated when a second part of the key-top is pressed;
a memory device having a conversion table stored therein and having inputs coupled to said first and second switches, said memory device producing an output having states unique to respective combinations of activation states of said first and second switches including simultaneous activation; and
a display device for displaying an indication corresponding to said output of said memory.

50. A data entry method comprising:
activating a first switch to provide a first output when a first part of a key-top is pressed;
activating a second switch to provide a second output when a second part of the key-top is pressed;
providing a first predetermined output according to a stored conversion table when the first and second switches are activated simultaneously;
providing a tutorial mode corresponding to a first conversion table to enable a user to learn about the input-output relationship based on the first conversion table;
providing a tutorial mode corresponding to a second conversion table to enable the user to learn about the input-output relationship based on the second conversion table; and
selecting one of the conversion tables as the conversion table to be used according to the user's preference.

51. A telecommunication device comprising:
a housing member for a wireless device;
a key board including a plurality of keys representative of a set of numbers including 0, 1, 2, 3, 4, 5, 6, 7, 8, and 9, the keyboard being coupled to the housing members;
one or more of the keys being representative of at least a first character and a second character, the one or more keys including a first portion and a second portion;
a first switch activated when the first portion of the key is pressed;
a second switch activated when a second portion of the key is pressed; and
a conversion device coupled to the first switch and the second switch, the conversion device having a first input coupled to the first switch, the conversion device having a second input coupled to the second switch, the first input being capable of transferring a first output indicative of the first character, the second input being capable of transferring a second output indicative of the second character.

52. The device of claim 51 wherein the conversion device is adapted to produce a third character upon receiving input from both the first switch activated when the first portion of the key and the second switch activated when the second portion of the key is pressed.

53. A remote controller device comprising:
a housing member for a wireless communications;
a key board including a plurality of keys representative of a set of numbers including 0, 1, 2, 3, 4, 5, 6, 7, 8, and 9, the keyboard being coupled to the housing member;
one or more of the keys being representative of at least a first character and a second character, the one or more keys including a first portion and a second portion;
a first switch activated when the first portion of the key is pressed;
a second switch activated when a second portion of the key is pressed; and
conversion device coupled to the first switch and the second switch, the conversion device having a first input coupled to the first switch, the conversion device having a second input coupled to the second switch, the first input being capable of transferring a first output indicative of the first character, the second input being capable of transferring a second output indicative of the second character.

54. A telecommunication device comprising:
a cellular phone device including a housing member;
a key board including a plurality of keys representative of a set of numbers including 0, 1, 2, 3, 4, 5, 6, 7, 8, and 9, the keyboard being coupled to the housing members;
one or more of the keys being representative of at least a first character and a second character, the one or more keys including a center portion, a first edge portion and a second edge portion;
a first switch activated when the first edge portion of the key is pressed;
a second switch activated when a second edge portion of the key is pressed; and
conversion device coupled to the first switch and the second switch, the conversion device having a first input coupled to the first switch, the conversion device having a second input coupled to the second switch, the first input being capable of transferring a first output indicative of the first character, the second input being capable of transferring a second output indicative of the second character.
